(19) United States
(12) Patent Application Publication
(10) Pub. No.: US 2026/0270608 A1
(43) Pub. Date: Sep. 10, 2026

(54) DISPLAY DEVICE HAVING SPEAKER

(71) Applicant: Wistron Corporation, New Taipei City (TW)

(72) Inventors: Xiao Qin Wang, New Taipei City (TW); Liping Pan, New Taipei City (TW); Chihwen Tu, New Taipei City (TW); Shang Pin Weng, New Taipei City (TW); Tzu Hsun Tseng, New Taipei City (TW); Yuh Ming Hsieh, New Taipei City (TW); Ching Hsuan Tsai, New Taipei City (TW)

(73) Assignee: Wistron Corporation, New Taipei City (TW)

(21) Appl. No.: 19/189,242

(22) Filed: Apr. 24, 2025

(30) Foreign Application Priority Data
Mar. 6, 2025 (TW) 114108386

(51) Int. Cl. H04R 1/24; G06F 1/16; G10K 11/178; H04R 1/02; H04R 1/08; H04R 1/26; H04R 1/40

(52) U.S. Cl. CPC H04R 1/24; G06F 1/1605; G10K 11/1785; H04R 1/025; H04R 1/08; H04R 1/26; H04R 1/403; H04R 2499/15

(57) ABSTRACT

A display device having a speaker includes a display, a main speaker, a stand, and a low-frequency woofer module. The main speaker is disposed on the display, and a sound output direction of the main speaker is inclined to a normal direction of a display surface of the display. The stand is connected to the display to support the display. The low-frequency woofer module is disposed at the stand.

### CROSS-REFERENCE TO RELATED APPLICATION

This application claims the priority benefit of Taiwan application serial no. 114108386, filed on March 6, 2025. The entirety of the above-mentioned patent application is hereby incorporated by reference herein and made a part of this specification.

### BACKGROUND

### Technical Field

The disclosure relates to a display device, and particularly relates to a display device having a speaker.

### Related Art

With the development of the gaming industry, gaming monitors have gradually become popular in the consumer market. Since the speakers of existing gaming monitors do not perform well in bass effects and surround sound effects, users need to wear over-ear headphones to properly experience realistic immersive sound effects when using gaming monitors. However, wearing over-ear headphones for a long time may easily make users feel tired and uncomfortable.

### SUMMARY

The disclosure provides a display device having a speaker, which can provide good bass effects through its own speaker and can avoid mid-high frequency sound attenuation.

The display device having the speaker of the disclosure includes a display, a main speaker, a stand, and a low-frequency woofer module. The main speaker is disposed on the display. The stand is connected to the display to support the display. The low-frequency woofer module is disposed at the stand.

In an embodiment of the disclosure, the low-frequency woofer module includes a low-frequency woofer and a passive radiator, the low-frequency woofer is disposed in the stand, and the passive radiator is disposed at a sidewall of the stand.

In an embodiment of the disclosure, the stand includes a support body and a housing, the display has a display surface and a back surface opposite to each other, the support body is connected to the back surface of the display to support the display, the housing covers the support body, the housing has a sidewall and an accommodating space, the low-frequency woofer is disposed in the accommodating space, and the passive radiator is adjacent to the accommodating space.

In an embodiment of the disclosure, the low-frequency woofer is located below the passive radiator.

In an embodiment of the disclosure, the display device includes two main speakers, in which the two main speakers are respectively located at opposite sides of a center of the display surface along a long edge direction of the display surface.

In an embodiment of the disclosure, the display device further includes a control unit, in which the control unit is configured to control the two main speakers to output interaural time difference (ITD) audio and interaural level difference (ILD) audio.

In an embodiment of the disclosure, the display device further includes a plurality of microphones, in which the microphones are disposed on the display and arranged along a long edge direction of the display surface.

The display device of the disclosure includes a display and a main speaker. The main speaker is disposed on the display, and a sound output direction of the main speaker is inclined to a normal direction of a display surface of the display.

In an embodiment of the disclosure, the main speaker is located below a display surface of the display or above the display surface.

In an embodiment of the disclosure, the display device having the speaker includes two main speakers, in which the two main speakers are respectively located at opposite sides of a center of the display surface along a long edge direction of the display surface.

In an embodiment of the disclosure, the display device having the speaker further includes a control unit, in which the control unit is configured to control the two main speakers to output interaural time difference audio and interaural level difference audio.

In an embodiment of the disclosure, the display device having the speaker further includes a plurality of microphones, in which the microphones are disposed on the display and arranged along a long edge direction of the display surface.

The display device having the speaker of the disclosure includes a display, a main speaker, a stand, and a low-frequency woofer module. The main speaker is disposed on the display, and a sound output direction of the main speaker is inclined to a normal direction of a display surface of the display. The stand is connected to the display to support the display. The low-frequency woofer module is disposed at the stand.

In an embodiment of the disclosure, the low-frequency woofer module includes a low-frequency woofer and a passive radiator, the low-frequency woofer is disposed in the stand, and the passive radiator is disposed at a sidewall of the stand.

In an embodiment of the disclosure, the stand includes a support body and a housing, the display has a display surface and a back surface opposite to each other, the support body is connected to the back surface of the display to support the display, the housing covers the support body, the housing has a sidewall and an accommodating space, the low-frequency woofer is disposed in the accommodating space, and the passive radiator is adjacent to the accommodating space.

In an embodiment of the disclosure, the low-frequency woofer is located below the passive radiator.

In an embodiment of the disclosure, the display device having the speaker includes two main speakers, in which the two main speakers are respectively located at opposite sides of a center of the display surface along a long edge direction of the display surface.

In an embodiment of the disclosure, the display device having the speaker further includes a control unit, in which the control unit is configured to control the two main speakers to output interaural time difference audio and interaural level difference audio.

In an embodiment of the disclosure, the main speaker is located below a display surface of the display or above the display surface.

In an embodiment of the disclosure, the display device having the speaker further includes a plurality of microphones, in which the microphones are disposed on the display and arranged along a long edge direction of the display surface.

### BRIEF DESCRIPTION OF THE DRAWINGS

FIG. 1 is a front view of a display device according to an embodiment of the disclosure.

FIG. 2 is a side view of the display device in FIG. 1.

FIG. 3 is a perspective view of the display device in FIG. 2.

FIG. 4 is a curve diagram of sound output of a main speaker and a low-frequency woofer module in FIG. 1.

FIG. 5 is an enlarged view of part of components of the display device in FIG. 1.

FIG. 6 is an enlarged view of part of components of a display device of a comparative example.

FIG. 7 is a curve diagram of sound output of the main speaker in FIG. 1 at various different inclination angles.

FIG. 8 is a schematic diagram of the display in FIG. 1 with microphones installed.

FIG. 9 is a block diagram of part of components of the display device in FIG. 1.

### DESCRIPTION OF THE EMBODIMENTS

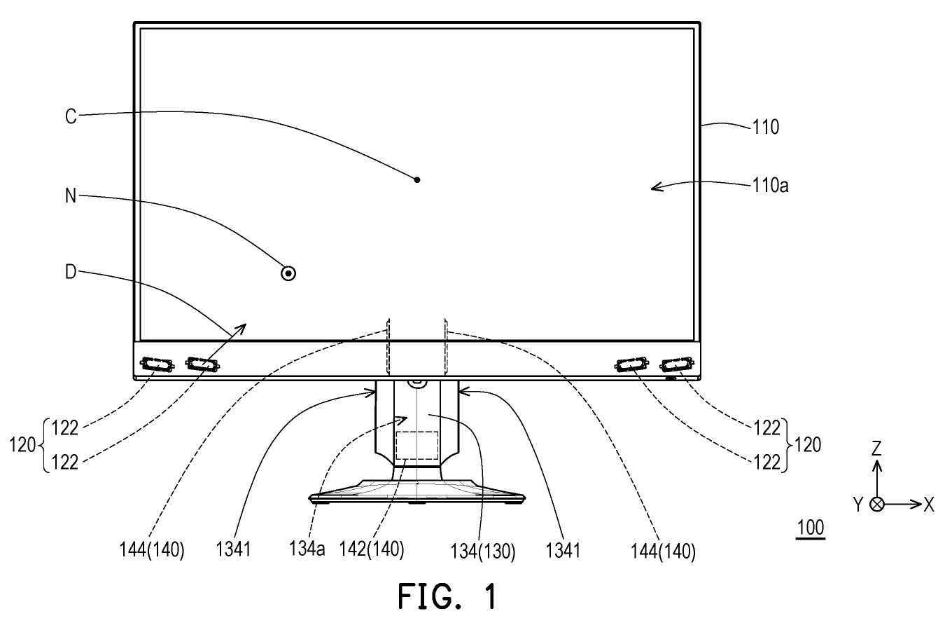

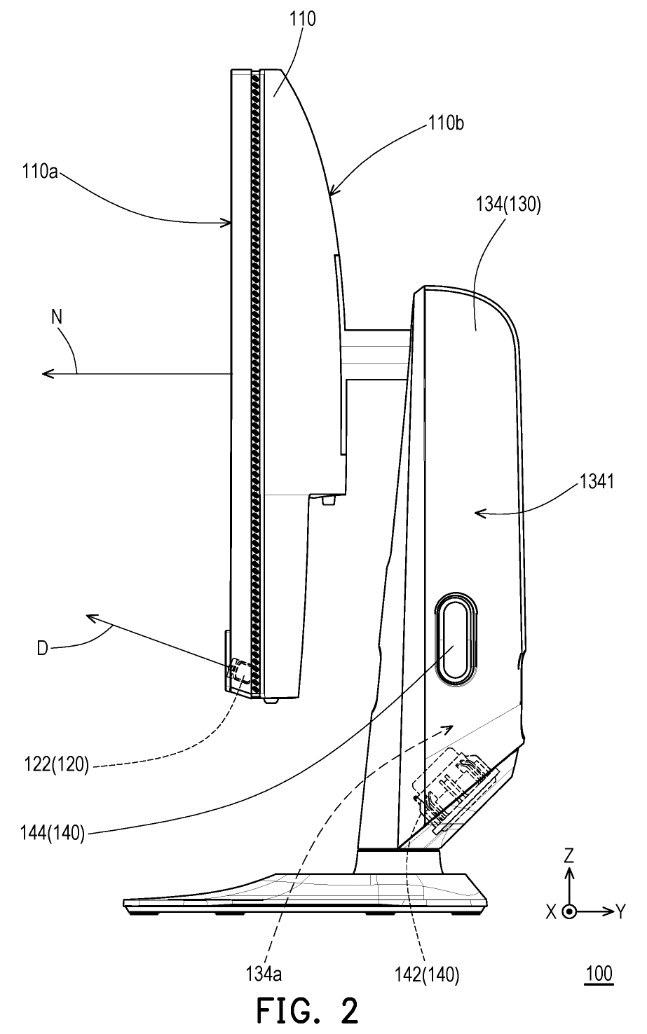

FIG. 1 is a front view of a display device according to an embodiment of the disclosure, which shows axial directions X, Y, and Z. FIG. 2 is a side view of the display device in FIG. 1. Referring to FIG. 1 and FIG. 2, a display device 100 of this embodiment is, for example, a gaming monitor and includes a display 110, two main speakers 120, a stand 130, and a low-frequency woofer module 140. The main speakers 120 are disposed on the display 110, and the stand 130 is connected to the display 110 to support the display 110. The low-frequency woofer module 140 is disposed at the stand 130.

As described above, the display device 100 of this embodiment, except having the main speakers 120 disposed on the display 110 for outputting mid-high frequency sounds, further has the low-frequency woofer module 140 additionally disposed at the stand 130 for outputting low-frequency sounds. The low-frequency woofer module 140 disposed at the stand 130 does not occupy the disposition space of the display 110. Also, since low-frequency sounds are non-directional, even though being located at the stand 130, the low-frequency woofer module 140 can still effectively deliver low-frequency sounds toward the ears of the user, so as to compensate for the insufficiency of low-frequency sound output from the main speakers. Therefore, the display device 100 of this embodiment can provide good bass sound effects through its own speakers.

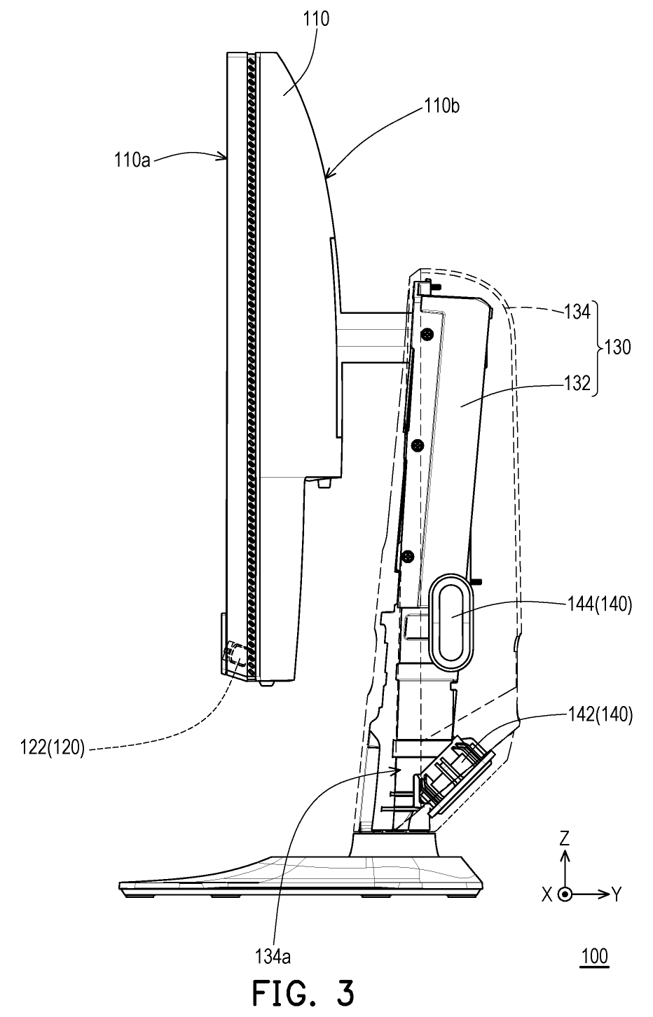

FIG. 3 is a perspective view of the display device in FIG. 2. Referring to FIG. 1 to FIG. 3, in detail, the stand 130 of this embodiment includes a support body 132 and a housing 134. The display has a display surface 110a and a back surface 110b opposite to each other, the support body 132 is connected to the back surface 110b of the display 110 to support the display 110, the housing 134 covers the support body 132, and the housing 134 has two sidewalls 1341 opposite to each other and an accommodating space 134a. The low-frequency woofer module 140 includes a low-frequency woofer 142 and two passive radiators 144. The two passive radiators 144 are respectively disposed at the two sidewalls 1341 of the housing 134 of the stand 130 and adjacent to the accommodating space 134a, and the low-frequency woofer 142 is disposed in the accommodating space 134a of the housing 134 of the stand 130 and located below the passive radiators 144. The accommodating space 134a is equivalent to a speaker cabinet of the low-frequency woofer module 140, and the low-frequency sounds emitted by the low-frequency woofer 142 resonate in the accommodating space 134a and drive the passive radiators 144 to vibrate, to enhance the bass sound effects.

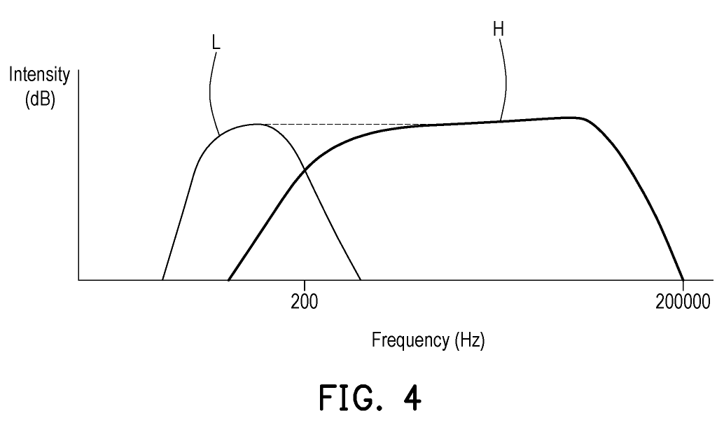

FIG. 4 is a curve diagram of sound output of the main speaker and the low-frequency woofer module in FIG. 1, where a curve H corresponds to the sound output of the main speakers 120, and a curve L corresponds to the sound output of the low-frequency woofer module 140. As shown by the curve H in FIG. 4, the main speakers 120 mainly provide mid-high frequency sounds of 200 to 20000 Hz, and as shown by the curve L in FIG. 4, the low-frequency woofer module 140 mainly provides low-frequency sounds below 200 Hz. In this way, the main speakers 120 in combination with the low-frequency woofer module 140 may completely cover the sound output requirements in a range of low frequency to high frequency.

Referring to FIG. 1 and FIG. 2, the main speakers 120 of this embodiment are disposed below the display surface 110a of the display 110. In other embodiments, the main speakers 120 may be disposed above the display surface 110a. Each main speaker 120 includes two speaker units 122, and each speaker unit 122 is disposed in an inclined manner such that a sound output direction D thereof is inclined to a normal direction N of the display surface 110a. In this way, even though the main speakers 120 are disposed above or below the display surface 110a and not at the height position of the ears of the user, the main speakers 120 may still output mid-high frequency sounds toward the direction of the ears of the user by means of the inclined disposition thereof, thereby avoiding high-frequency sound pressure attenuation due to the highly directional mid-high frequency sounds not being output directly toward the ears of the user. The inclined manner of the main speakers 120 of this embodiment is specifically described below.

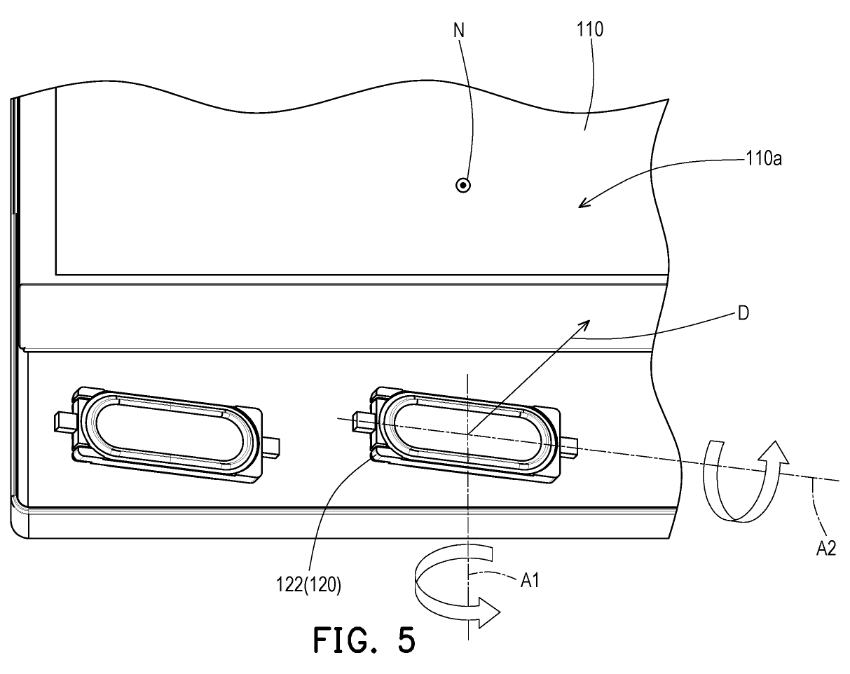

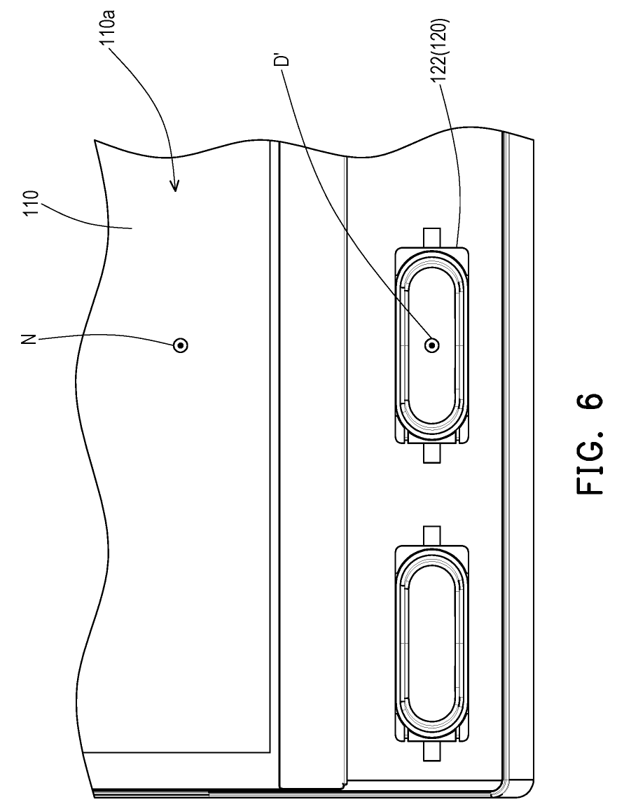

FIG. 5 is an enlarged view of part of components of the display device in FIG. 1. FIG. 6 is an enlarged view of part of components of a display device of a comparative example. In the comparative example shown in FIG. 6, each speaker unit 122 is not disposed in an inclined manner, and a sound output direction D' thereof is parallel to the normal direction N of the display surface 110a. Each speaker unit 122 of this embodiment, based on the state in FIG. 6, is rotated by a specific angle around a vertical axis A1 and rotated by a specific angle around a horizontal axis A2 as shown in FIG. 5, and inclined toward a center C (marked in FIG. 1) of the display surface 110a.

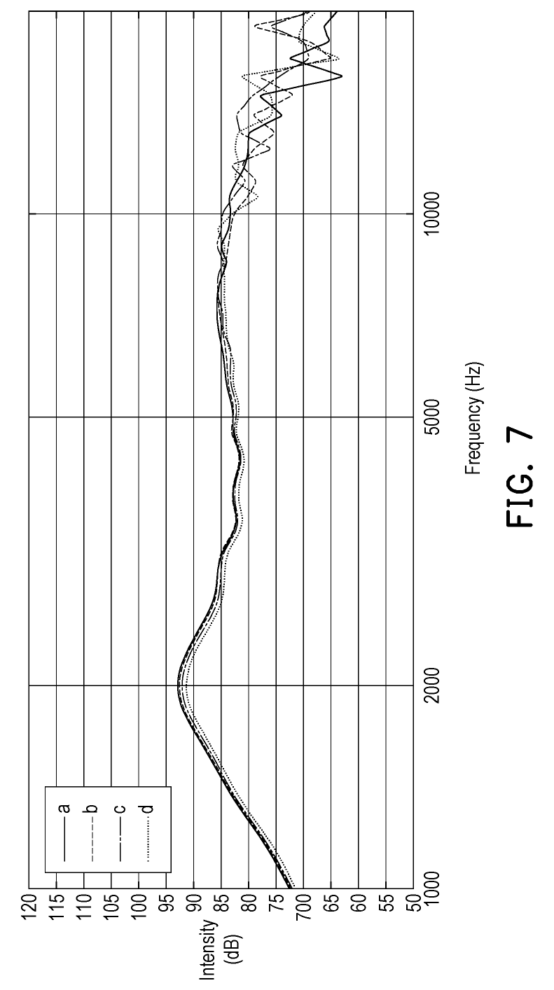

FIG. 7 is a curve diagram of sound output of the main speakers in FIG. 1 at various inclination angles, in which under the conditions that the width of the display surface 110a is approximately 612 mm, the driving voltage of the speaker unit 122 is 2 volts, and the sound capturing position is at a position 500 mm in front of the center C of the display surface 110a, a curve a corresponds to the speaker unit 122 rotated 20 degrees around the vertical axis A1 and 0 degrees around the horizontal axis A2, a curve b corresponds to the speaker unit 122 rotated 20 degrees around the vertical axis A1 and 10 degrees around the horizontal axis A2, a curve c corresponds to the speaker unit 122 rotated 20 degrees around the vertical axis A1 and 20 degrees around the horizontal axis A2, and a curve d corresponds to the speaker unit 122 rotated 20 degrees around the vertical axis A1 and 30 degrees around the horizontal axis A2. As shown in FIG. 7, the speaker unit 122 rotated 20 degrees around the vertical axis A1 and 20 degrees around the horizontal axis A2 corresponding to the curve c has relatively good sound output performance, so the inclined manner corresponding to the curve c may be adopted to dispose the speaker unit 122. In other embodiments, the inclination angle of the speaker unit 122 may be changed according to requirements, and the disclosure is not limited thereto.

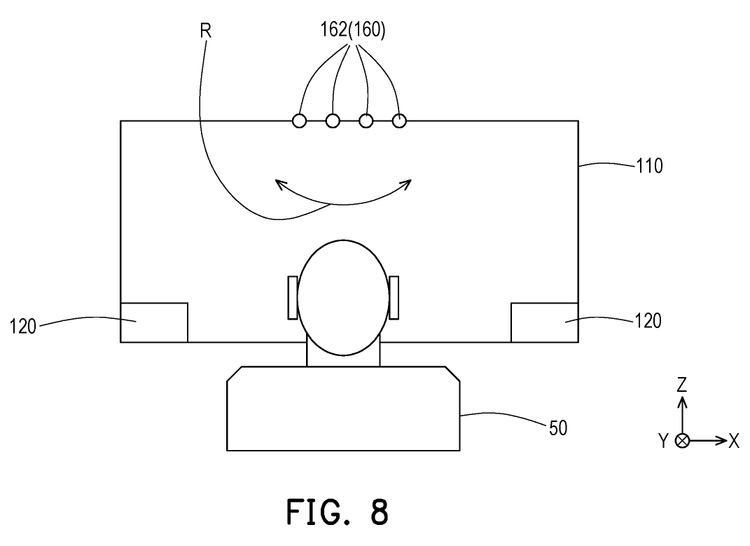

FIG. 8 is a schematic diagram of the display in FIG. 1 with microphones installed. Referring to FIG. 8, the display device of this embodiment further includes a microphone array 160. The microphone array 160 includes multiple microphones 162, the microphones 162 are disposed on the display 110 and arranged along a long edge direction (the axial direction X) of the display surface 110a. In this way, the microphones 162 arranged horizontally may be used to capture the voice of a user 50 within a large angular range R (for example, 65 degrees).

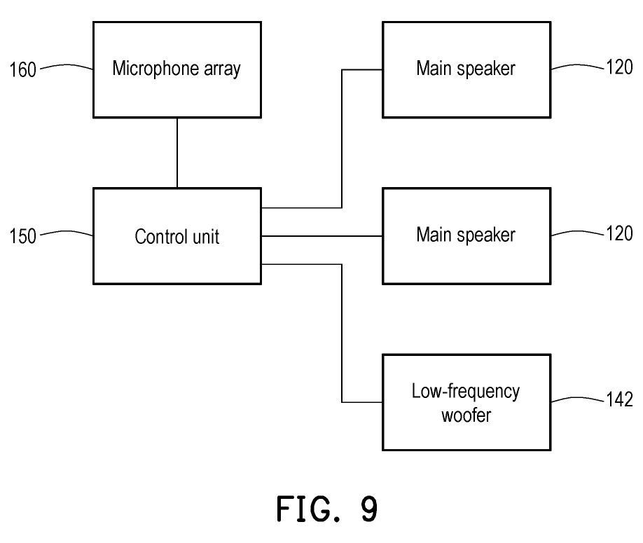

FIG. 9 is a block schematic diagram of part of components of the display device in FIG. 1. Referring to FIG. 9, the display device 100 of this embodiment further includes a control unit 150, the control unit 150 is disposed, for example, in the display 110 and coupled to each main speaker 120, the low-frequency woofer 142, and the microphone array 160, to filter out background noise from the sound captured by the microphone array 160 based on an algorithm, and to control the sound output of each main speaker 120 and the low-frequency woofer 142 based on an algorithm.

Specifically, the two main speakers 120 as shown in FIG. 1 are respectively positioned at opposite sides of the center C of the display surface 110a along the long edge direction (the axial direction X) of the display surface 110a. The control unit 150 shown in FIG. 8 may control the two main speakers 120 to output interaural time difference (ITD) audio and interaural level difference (ILD) audio based on an algorithm, so as to simulate stereo scene sound effect.

In summary, in the display device of the embodiment of the disclosure, the main speakers are disposed in an inclined manner. In this way, even though the main speakers are disposed above or below the display surface and not at the height position of the ears of the user, the main speakers may still output mid-high frequency sounds toward the direction of the ears of the user by means of the inclined disposition thereof, thereby avoiding high-frequency sound pressure attenuation due to the highly directional mid-high frequency sounds not being output directly toward the ears of the user. In addition, the display device of the embodiment of the disclosure further has a low-frequency woofer module additionally disposed at the stand. The low-frequency woofer module disposed at the stand does not occupy the disposition space of the display. Also, since low-frequency sounds are non-directional, even though being located at the stand, the low-frequency woofer module can still effectively deliver low-frequency sounds toward the ears of the user, so as to compensate for the insufficiency of low-frequency sound output from the main speakers.

What is claimed is:

1. A display device having a speaker, comprising:
a display;
a main speaker disposed on the display;
a stand connected to the display to support the display; and
a low-frequency woofer module disposed at the stand.

2. The display device having the speaker as claimed in claim 1, wherein the low-frequency woofer module includes a low-frequency woofer and a passive radiator, the low-frequency woofer is disposed in the stand, and the passive radiator is disposed at a sidewall of the stand.

3. The display device having the speaker as claimed in claim 2, wherein the stand includes a support body and a housing, the display has a display surface and a back surface opposite to each other, the support body is connected to the back surface of the display to support the display, the housing covers the support body, the housing has a sidewall and an accommodating space, the low-frequency woofer is disposed in the accommodating space, the passive radiator is adjacent to the accommodating space.

4. The display device having the speaker as claimed in claim 2, wherein the low-frequency woofer is located below the passive radiator.

5. The display device having the speaker as claimed in claim 1, comprising two main speakers, wherein the two main speakers are respectively located at opposite sides of a center of the display surface along a long edge direction of the display surface.

6. The display device having the speaker as claimed in claim 5, further comprising a control unit, wherein the control unit is configured to control the two main speakers to output interaural time difference audio and interaural level difference audio.

7. The display device having the speaker as claimed in claim 1, further comprising a plurality of microphones, wherein the microphones are disposed on the display and arranged along a long edge direction of the display surface.

8. A display device having a speaker, comprising:
a display; and
a main speaker disposed at the display, wherein a sound output direction of the main speaker is inclined to a normal direction of a display surface of the display.

9. The display device having the speaker as claimed in claim 8, wherein the main speaker is located below a display surface of the display or above the display surface.

10. The display device having the speaker as claimed in claim 8, comprising two main speakers, wherein the two main speakers are respectively located at opposite sides of a center of the display surface along a long edge direction of the display surface.

11. The display device having the speaker as claimed in claim 10, further comprising a control unit, wherein the control unit is configured to control the two main speakers to output interaural time difference audio and interaural level difference audio.

12. The display device having the speaker as claimed in claim 8, further comprising a plurality of microphones, wherein the microphones are disposed on the display and arranged along a long edge direction of the display surface.

13. A display device having a speaker, comprising:
a display;
a main speaker disposed on the display, wherein a sound output direction of the main speaker is inclined to a normal direction of a display surface of the display;
a stand connected to the display to support the display; and
a low-frequency woofer module disposed at the stand.

14. The display device having the speaker as claimed in claim 13, wherein the low-frequency woofer module includes a low-frequency woofer and a passive radiator, the low-frequency woofer is disposed in the stand, and the passive radiator is disposed at a sidewall of the stand.

15. The display device having the speaker as claimed in claim 14, wherein the stand includes a support body and a housing, the display has a display surface and a back surface opposite to each other, the support body is connected to the back surface of the display to support the display, the housing covers the support body, the housing has a sidewall and an accommodating space, the low-frequency woofer is disposed in the accommodating space, the passive radiator is adjacent to the accommodating space.

16. The display device having the speaker as claimed in claim 14, wherein the low-frequency woofer is located below the passive radiator.

17. The display device having the speaker as claimed in claim 13, comprising two main speakers, wherein the two main speakers are respectively located at opposite sides of a center of the display surface along a long edge direction of the display surface.

18. The display device having the speaker as claimed in claim 17, further comprising a control unit, wherein the control unit is configured to control the two main speakers to output interaural time difference audio and interaural level difference audio.

19. The display device having the speaker as claimed in claim 13, wherein the main speaker is located below a display surface of the display or above the display surface.

20. The display device having the speaker as claimed in claim 13, further comprising a plurality of microphones, wherein the microphones are disposed on the display and arranged along a long edge direction of the display surface.
